(19) United States
(12) Patent Application Publication
(10) Pub. No.: US 2025/0138485 A1
(43) Pub. Date: May 1, 2025

(54) COUPLING DEVICE OF A SYSTEM FOR OPERATING A HOROLOGICAL MOVEMENT

(71) Applicant: OMEGA SA, Biel (CH)

(72) Inventors: Philippe LOETSCHER, Evilard (CH); Félicien Villard, Biel (CH)

(73) Assignee: OMEGA SA, Biel (CH)

(21) Appl. No.: 18/810,969

(22) Filed: Aug. 21, 2024

(30) Foreign Application Priority Data
Oct. 25, 2023 (EP) 23205764.6

(51) Int. Cl. G04B 27/00; G04B 3/04

(52) U.S. Cl. CPC G04B 27/004; G04B 3/046

(57) ABSTRACT

A system (1) for operating a horological movement of a watch, which system including a coupling device (40) configured to operate at least one function of this movement by including a control device (2) and a support piece (3) intended to be unmoving relative to the horological movement of the watch and in which piece (3) this control device (2) is movably mounted, the control device (2) including a gripping element (7) capable of being driven in a rotational motion, a first drive element (31) including the first coupling end (32) and the first drive zone (36), and a second drive element (8) mounted such that it is rigidly connected to the gripping element (7), this second drive element (8) including the second coupling end (33) and the second drive zone (37).

### CROSS REFERENCE TO RELATED APPLICATIONS

This application claims priority to European Patent Application No. 23205764.6 filed Oct. 25, 2023, the entire contents of which are incorporated herein by reference.

### TECHNICAL FIELD OF THE INVENTION

The invention relates to the field of watchmaking, and in particular to systems for operating a horological movement of a watch, which systems comprise a coupling device.

### TECHNOLOGICAL BACKGROUND

In the prior art, operating systems such as push buttons are known to be fitted to certain watches, in particular watches referred to as having numerous complications, which can include a large number of functions. These push buttons are of various types, including miniature push buttons which are typically embedded in the middle of the watch.

Miniature push buttons of this kind are usually very small, which saves space, particularly in the case of these watches. Moreover, they do not project from the middle and are thus unlikely to be activated unintentionally.

However, one of the drawbacks of such push buttons is that they necessarily require the use of a pointed actuating tool when carrying out operations to operate a watch function, such as setting the time, a date, a moon phase or a day of the month. More specifically, such a use entails a considerable risk of damaging the watch case and thus of altering its aesthetic appearance.

In these circumstances, it is clear that there is a need to find a solution to overcome these drawbacks of the prior art.

### SUMMARY OF THE INVENTION

One of the aims of the invention is to provide an operating system for a watch allowing the functions of this watch to be operated without the need for an actuating tool.

To this end, the invention relates to a system for operating a horological movement of a watch, which system comprises a coupling device provided with first and second coupling ends and first and second drive zones, said coupling device being configured to operate at least one function of this movement by comprising a control device and a support piece intended to be unmoving relative to the horological movement of the watch and in which piece this control device is movably mounted, the control device comprising:
a gripping element capable of being driven in a rotational motion about a longitudinal axis of the coupling device;
a first drive element including the first coupling end and the first drive zone;
a second drive element mounted such that it is rigidly connected to the gripping element, this second drive element including the second coupling end and the second drive zone, said second zone being able to be joined to the first drive zone in order to drive the first drive element such that it rotates;
   said elements being configured to transmit this rotational motion to a functional member of the movement when said gripping element is arranged in an axial position for operating said function.

In other embodiments:
the body of the first drive element is arranged in the hollow body of the second drive element;
a part of the body of the first drive element provided with the first coupling end projects from an opening formed in the second coupling end of the hollow body of the second drive element;
the first and second drive elements are coaxial;
the first coupling end of the first drive element is configured to be arranged in the movement of the watch when the gripping element is in any of its axial positions;
the second coupling end of the second drive element is configured to be arranged outside the movement of the watch when the gripping element is in any of its axial positions;
the first coupling end is configured to transmit said rotational motion to an actuating member of a manual winding mechanism of said system, which mechanism is capable of storing mechanical energy when said gripping element is arranged in a first axial position for operating a first function of the watch, and in which first position the first and second drive zones are joined together;
the first coupling end is configured to transmit said rotational motion to a hand-setting member of said system when said gripping element is arranged in a second axial position for operating a second function of the watch, and in which second position the first and second drive zones are joined together;
the second coupling end is configured to transmit said rotational motion to an operating member of said system when said gripping element is arranged in a third axial position for operating third and fourth functions of the watch, in which third position the first and second drive zones are separated from each other;
the first drive element can translate axially and can rotate about the longitudinal axis relative to the second drive element;
the first drive zone is formed on an outer surface of the first drive element and the second drive zone is formed on an inner surface of the second drive element;
the first and second drive zones are arranged opposite each other in the coupling device;
the first and second drive zones are configured to cooperate with each other in frictional contact so as to transmit the rotational motion of the gripping element to the first drive element via the second drive element.

The invention further relates to a watch comprising such an operating system.

### BRIEF DESCRIPTION OF THE FIGURES

Other features and advantages of the invention will be better understood upon reading the following description given of a non-limiting specific embodiment of the invention, provided for illustration purposes with reference to the accompanying figures, in which:

FIGS. 1 to 3 show different views of the system for operating a horological movement comprising a coupling device provided with two coupling ends and two drive zones capable of participating in the operation/control/management of functions of said movement, according to one embodiment of the invention;

FIG. 4 shows a view of the coupling device comprising a control device including first and second drive elements mounted such that they are rigidly connected to a gripping element of this device, this gripping element being placed in a first axial position for controlling a first function of the watch, according to the embodiment of the invention;

FIG. 5 shows a view of the coupling device comprising the control device including the first and second drive elements mounted such that they are rigidly connected to a gripping element of this device, this gripping element being placed in a second axial position for controlling a second function of the watch, according to the embodiment of the invention;

FIG. 6 shows a view of the coupling device comprising the control device including the first and second drive elements mounted such that they are rigidly connected to a gripping element of this device, this gripping element being placed in a third axial position for controlling a third function of the watch, according to the embodiment of the invention;

FIG. 7 shows a view of the coupling device comprising the control device including the first and second drive elements mounted such that they are rigidly connected to a gripping element of this device, this gripping element being placed in the third axial position for controlling a fourth function of the watch, according to the embodiment of the invention;

FIGS. 8a and 8b show views of a portion of an outer peripheral wall of a casing ring of an operating member of the operating system, said portion comprising a through-hole having at least one zone for passing the second coupling end of the second drive element of the control device for operating the third and fourth functions of the watch, according to the embodiment of the invention;

FIG. 9 shows a view of the portion of the outer peripheral wall of the casing ring when the free end of the rotary drive element is inserted in the corresponding passage zone of the through-hole for operating the third and fourth functions of the watch, according to the embodiment of the invention;

FIG. 10 shows a view of the control device comprising the gripping element placed in the third axial control position after this gripping element has been rotated to operate the third function, according to the embodiment of the invention; and

FIG. 11 shows a view of the control device comprising the gripping element placed in the third axial control position after the gripping element has been driven in a rotational motion to operate the fourth function, according to the embodiment of the invention.

### DETAILED DESCRIPTION OF THE INVENTION

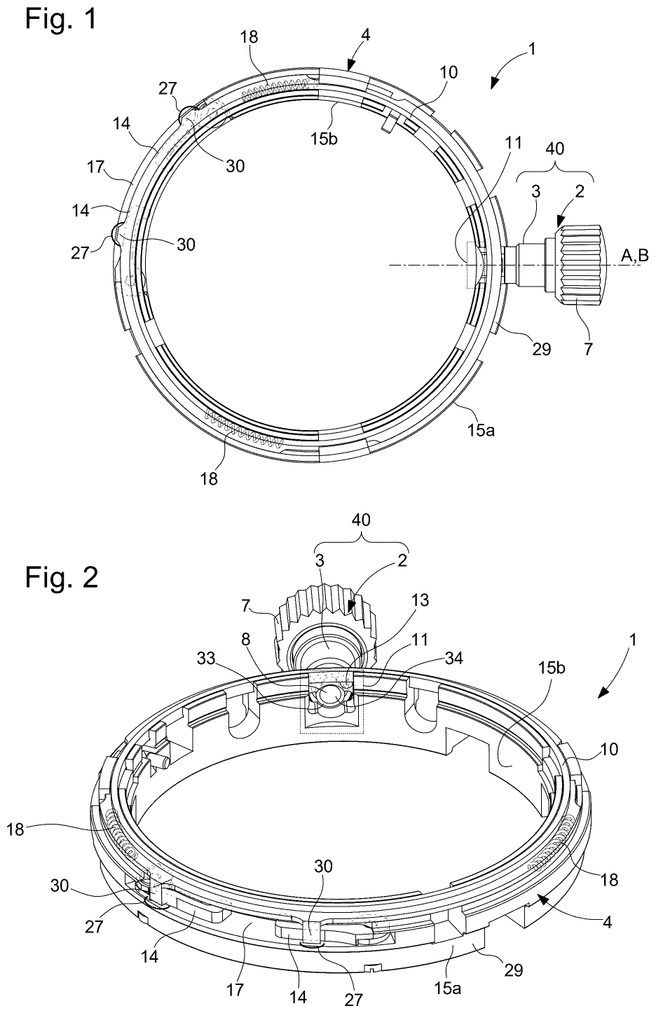

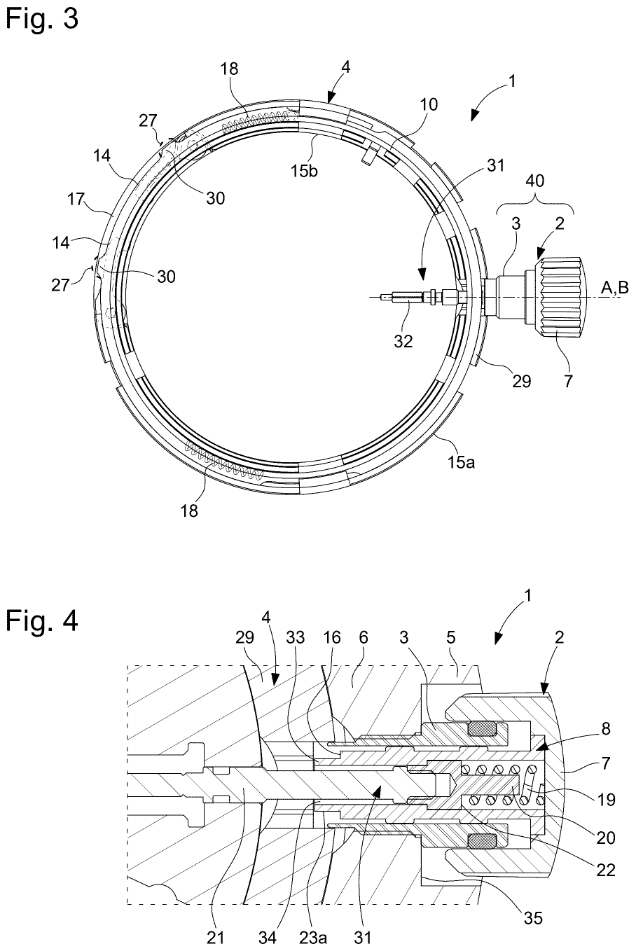

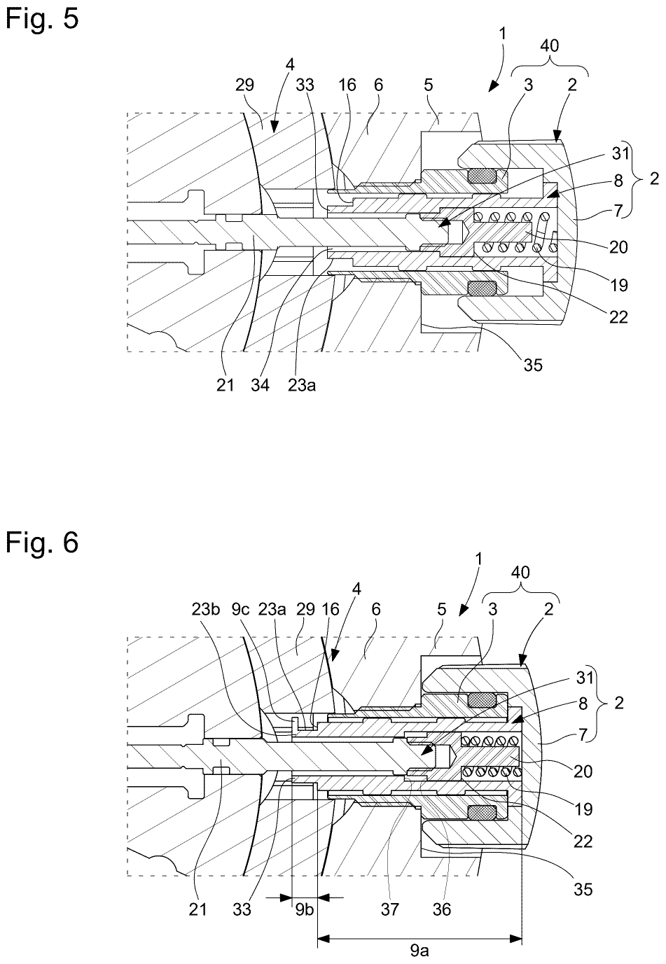

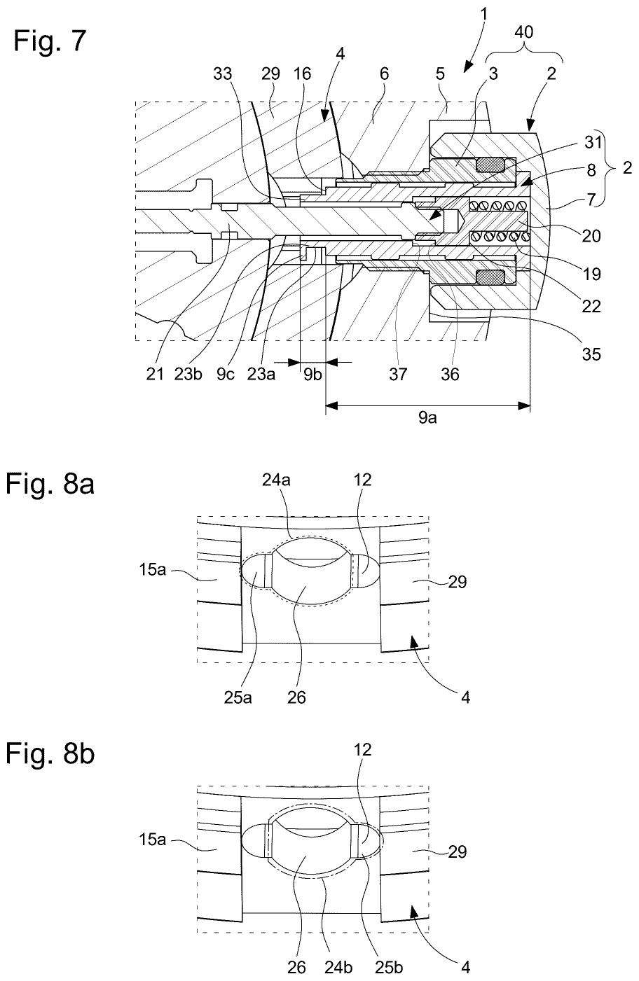

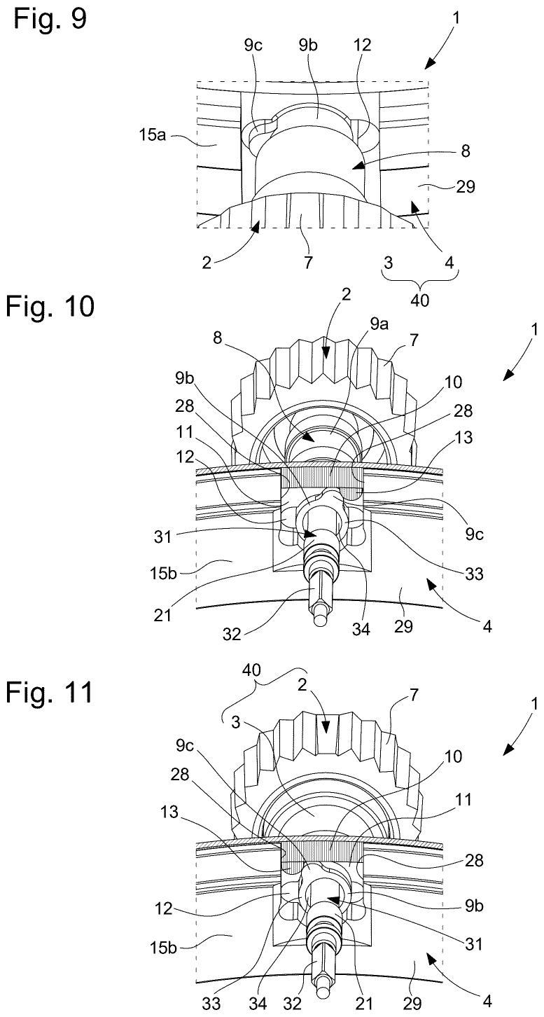

With reference to FIGS. 1 to 11, the present invention relates to a watch, also referred to as a timepiece, such as a wristwatch comprising a system 1 for operating a horological movement of a watch, which system comprises a coupling device 40 provided with first and second coupling ends 32, 33, and first and second drive zones 36, 37. This coupling device 40 is configured to operate at least one function of this movement. For a better understanding of the invention, the embodiment described here relates to an operating system 1 which is configured to implement, in a non-limiting and non-exhaustive manner, four functions, namely: first, second, third and fourth functions.

In the conventional manner, the watch comprises a case 5 formed by a middle 6, which is preferably circular in shape, defining a central internal recess intended to receive the horological movement, the external contour of which matches the internal shape of a casing ring 29. This watch can be fitted with screws or clamps to hold the movement in this casing ring 29 as well as to hold this casing ring 29 in the middle 6 of the watch case 5.

Such a horological movement can be a mechanical or quartz movement. As seen above, this movement is configured to implement at least one horological function and, in the present embodiment, four horological functions. These functions are controlled from the coupling device 40 for the purposes of adjusting, correcting or activating mechanisms of this movement or functional members thereof. It should be noted that such functions are preferably operated independently of one another by actuating a gripping element 7 of a control device 2 included in this coupling device 40. In this context, this coupling device 40 can be considered to be a device 40 allowing it to participate in the control or management of a mechanism of the movement or of a functional member thereof in order to implement a function of the watch.

It is understood that this movement is adapted to perform the functions, in particular by means of separate mechanisms and/or separate functional members of the movement, which can be kinematically linked together. By way of example, each mechanism or member can in practice lead to a separate display on the watch, such as, for example, the display of the current time on the one hand and a date or a moon phase on the other. This mechanism or member can further comprise a manual winding mechanism capable of storing mechanical energy. The movement and its functions are operated and/or controlled by the operating system and in particular by the coupling device 40.

For this purpose, the system 1 thus comprises the coupling device and the functional members 4 allowing the one or more functions of the watch to be operated. These functional members include, for example, a member for actuating a manual winding mechanism capable of storing mechanical energy, a hand-setting member or an operating member 4, the operation of which will be described in greater detail below.

In this configuration, the coupling device 40 includes a support piece 3 and the control device 2 which can, for example, be a push button with a rotating head or a crown or a crown with a push button, a winding button or any crown allowing the horological movement to be operated.

In this coupling device 40, the support piece 3, which can also be referred to as the “support and guide piece”, is preferably a tube provided with a through-opening which is configured to provide sliding guidance. This tube is intended to be fixedly engaged in a through-orifice extending radially in the middle 6 of the watch. Thus, in this configuration, this piece 3 is arranged such that it is unmoving relative to the horological movement.

The control device 2 is movably mounted in this through-opening in the support piece 3. Such a control device 2 is intended to be engaged through the middle 6 of the case 5 of this watch by means of this support piece 3. This control device 2 includes:
the gripping element 7;
a first rotary drive element 31 which comprises the first coupling end 32 and the first drive zone 36 of the coupling device 40;
a second rotary drive element 8 which is formed by a hollow body consisting of a tubular extension rigidly connected to this gripping element 7 and which comprises the second coupling end 33 and the second drive zone 37 of the coupling device 40.

In this control device 2, the second drive element 8 is arranged essentially in the support piece 3 and is also configured to be moved or even slid in the opening provided in this piece 3.

The hollow body of this second drive element 8 comprises three parts, namely: a fastening part 9a connected to the gripping element 7, an insertable part 9b capable of being inserted into the through-hole 12 and a coupling portion 9c configured to cooperate with the operating member 4 in order to participate in operating the third or fourth function of the watch. It should be noted that this coupling portion 9c is included in the second coupling end 33 of this second drive element 8 of the coupling device 40. In the body of this second drive element 8, the insertable part 9b is arranged successively to the fastening part 9a. These two parts 9a, 9b are moreover connected to each other by a shoulder 16 formed on the outer surface of the body of this second drive element 8, as can be seen in FIGS. 4 to 7. The insertable part 9b consists of a main portion 23a and a terminal portion 23b. In this configuration, the main portion 23a is between the shoulder 16 and the terminal portion 23b.

In this second drive element 8, the coupling portion 9c extends perpendicularly to an outer surface of the insertable part 9b. More particularly, this coupling portion 9c extends substantially perpendicular to a zone of this surface included in the terminal portion 23b of the insertable part 9b. In other words, this coupling portion 9c extends substantially perpendicularly to the longitudinal axis A of the control device 2. Such a longitudinal axis A is also a central axis of the coupling device 40 and thus of the control device 2 and of the support piece 3.

Thus, the insertable part 9b and the coupling portion 9c together form the second coupling end 33 of the second drive element 8. In other words, such a second end 33 is thus formed by the main and terminal portions 23a, 23b as well as by the coupling portion 9c. In this context, the coupling portion 9c thus extends substantially perpendicularly to the surface of this second end 33.

Moreover, it should be noted that the fastening part 9a of the second drive element 8 can be driven into the gripping element 7 or be formed integrally in one piece with this gripping element 7. In this configuration, it is understood that this second drive element 8 is translated axially or rotated under the impetus/actuation of the gripping element 7. As mentioned above, this second drive element 8 comprises a shoulder, given the reference numeral 16 in FIGS. 4 to 7, which connects the fastening and insertable parts 9a, 9b together. Such a shoulder 16 preferably has a flat surface. It should be noted that such a surface is also substantially perpendicular to the longitudinal axis A.

Furthermore, as mentioned above, this second drive element 8 comprises the second drive zone 37 which is formed in its inner surface. More specifically, this second drive zone 37 is formed in a portion of the inner surface located in the fastening part 9a of the second drive element 8. This second drive zone 37 comprises a contact face which is substantially perpendicular to the longitudinal axis A.

In this control device 2, the first drive element 31 comprises the first coupling end 32 of the coupling device 40, said first end 32 being mounted such that it is rigidly connected to the gripping element 7. This first end 32 is one end of a rod 21 which is included in this first drive element 31.

Such a first drive element 31 further comprises a spring 19 which is mounted freely in a cylindrical recess defined in the hollow body of the second drive element 8, in particular in the fastening part 9a which is fastened to the gripping element 7 of the control device 2. This first drive element 31 further comprises a compression piece 20 for compressing this spring 19, which compression piece bears on the rod 21. This compression piece 20 comprises a shoulder 22 forming a bearing zone for a first end of the spring 19, the shoulder 22 being located facing the gripping element 7, which in turn forms the other bearing zone capable of cooperating with the second end of this spring 19. It should be noted that the shoulder 22 is located facing an internal face of this gripping element 7, this face forming the other bearing zone capable of cooperating with the second end of this spring 19.

In this configuration, the first drive element 31 is partly arranged in the hollow body of the second drive element 8. More specifically, in this configuration, a part of the body of the first drive element 31 provided with the first coupling end 32 projects from the opening 34 formed in the second coupling end 33 of the hollow body of the second drive element 8.

Furthermore, as mentioned above, this first drive element 31 comprises the first drive zone 36 which is formed in its outer surface. This first drive zone 36 comprises a contact face which is substantially perpendicular to the longitudinal axis A.

It should be noted that the first and second drive zones 36, 37, in particular the contact faces thereof, are arranged facing each other in the coupling device 40. Moreover, these first and second drive zones 36, 37, in particular the contact faces thereof, are configured to cooperate with each other in frictional contact so as to transmit the rotational motion of the gripping element 7 to the first drive element 31 via the second drive element 8.

In the coupling device 40, the first and second drive elements 31, 33 are coaxial. In other words, this first drive element 31 and this second drive element 8, as well as these first and second coupling ends 32, 33, have the same central axis which is the longitudinal axis A.

In this context, the first coupling end 32 is configured so as to be arranged in the movement of the watch when the gripping element 7 is in any of the axial positions that it can occupy, and the second coupling end 33 is configured so as to be arranged outside the movement of the watch when this gripping element 7 is in any of the axial positions that it can occupy. Finally, it should be noted that the first drive element 31 can translate axially and can rotate about the longitudinal axis A, relative to the second drive element 8.

Similarly, the first coupling end 32 can translate axially and can rotate about the longitudinal axis A, relative to the second coupling end 33.

In the coupling device 40, the first coupling end 32 is configured in particular to:
communicate/transmit the rotational motion applied to the gripping element 7 of the control device 2:
   to the actuating member of the manual winding mechanism when said gripping element 7 is arranged in the first axial position for operating the first function of the watch, in which first position the first and second drive zones 36, 37 are joined together to participate in the transmission of this rotational motion; or.
   to the hand-setting member when said gripping element 7 is arranged in the second axial position for operating the second function of the watch, in which second position the first and second drive zones 36, 37 are joined together to participate in the transmission of this rotational motion;
improve cooperation between the coupling portion 9c and the coupling element 13 in order to ensure optimum displacement of the ring 10 in the support zone of the casing ring 29.

In these circumstances, this first coupling end 32 can be referred to as the winding and/or hand-setting end of the watch.

The second coupling end 33 of the first drive element 31 is configured in particular to transmit the rotational motion of the gripping element 7 to the operating member 4 of said system 1 when said gripping element 7 is arranged in a third axial position for operating the third or fourth function of the watch. In this third position of the gripping element 7, the first and second drive zones 36, 37 are separate. In other words, in this configuration, when the gripping element 7 is actuated rotatably, only the second drive element 8 performs this rotational motion due to the fact that this element 8 is both mounted such that it is rigidly connected to this gripping element 7 and the fact that the first and second zones 36, 37 are separate from each other, i.e. not in contact with each other.

As mentioned above, the operating system 1 is able to implement a plurality of functions of the movement depending on different axial positions of the gripping element 7 relative to the movement or relative to an outer surface 35 of the middle 6 of this watch and further depending on the direction of rotation of this gripping element 7 in the selected axial position.

More specifically, the control device 2, which comprises the gripping element 7, is mounted so as to be movable in the support piece 3 by being actuated rotatably, and by being pulled away from or pushed towards its longitudinal axis A, relative to this support piece 3. In these circumstances, the gripping element 7 is configured to be displaced axially relative to its longitudinal axis A between the first, second and third axial control positions for carrying out the first, second, third and fourth functions of the watch respectively.

More specifically, when this gripping element 7 is placed in the first control position in order to operate the first function of this watch, the first coupling end 32 is then mechanically connected to the actuating member and the first and second drive zones 36, 37 are joined together. In this configuration, this first end 32 then transmits to the actuating member the rotational motion of the gripping element 7 due to the cooperation of the first and second drive zones 36, 37 with each other.

This first control position can also be referred to as the winding position. It should be noted that such a first position can also be referred to as the neutral axial position or initial axial position because it can be the default or rest or initial position of the gripping element 7 or of the control device 2.

In such a case, this first control position is preferably between the second and third axial control positions. In other words, to place the gripping element 7 in:
the second control position, starting from the first position, the gripping element 7 and thus the control device 2 is thus displaced axially along the longitudinal axis A of this first control position in a direction opposite to that directed towards the movement or the outer surface 35 of the middle 6 of the watch, i.e. in a direction working to move the gripping element 7 away from the movement or the outer surface 35 of the middle 6 of the watch, and during this axial displacement, the first and second drive zones 36, 37 remain joined together;
the third control position, starting from the first position, this gripping element 7 and thus the control device 2 is thus displaced axially along the longitudinal axis A of this first control position in a direction towards the movement or the outer surface 35 of the middle 6 of the watch, and during this axial displacement, the first and second drive zones 36, 37 are thus separated from one another.

When, when this gripping element 7 is placed in the second control position in order to operate the second function of this watch, the first coupling end 32 is then mechanically connected to the hand-setting member and the first and second drive zones 36, 37 are joined together. In this configuration, this first end 32 then transmits to the hand-setting member the rotational motion of the gripping element 7 due to the cooperation of the first and second drive zones 36, 37 with each other.

Finally, when this gripping element 7, and thus the control device 2, is placed in the third control position, a mechanical link is then established between the second coupling end 33 and the ring 10 of the operating member 4, to transmit, to this said ring 10, a rotational motion of the gripping element 7 in order to implement the third or fourth function of the watch. In this configuration, the first and second drive zones 36, 37 are separate, i.e. they are no longer in contact so that the rotational motion of the gripping element 7 is not transmitted to the first drive element 31.

This operating member 4 is preferably configured to be connected to the horological movement, in particular when a mechanism of this movement is activated to perform the third or fourth function of the watch. For this purpose, this member 4 comprises the casing ring 29, a ring 10, at least one first resilient return element 18 and at least one movable actuating element 30.

In this member 4, the casing ring 29, also referred to as the encasing ring, can have various shapes insofar as it surrounds the horological movement and is placed inside the middle 6 of the case 5. In the present embodiment, this casing ring 29 is preferably substantially circular in shape. Such a casing ring 29 comprises upper and lower faces as well as inner and outer peripheral walls connecting these two faces together.

In this configuration, the upper face of the casing ring 29 comprises a support zone intended to accommodate or receive the ring 10 as part of its arrangement in this casing ring 29. This support zone comprises a flat surface, the lateral edges of which are wholly or partially raised over the entire length of this zone, in order to ensure that the ring 10 is held and guided on this surface, in particular when this ring 10 is displaced. Such a surface of the support zone further comprises an open recess configured to receive each first resilient return element 18 of this member 4. In this configuration, the first resilient return element 18, which can be a helical spring, is thus arranged below the ring 10. As will be seen below, the first resilient return element 18 is intended to automatically return the ring 10 to its rest position after it has been biased for the operation of the third or fourth function of the watch.

The casing ring 29 of this member 4 further comprises a through-hole 12 connecting its inner and outer peripheral walls 15a, 15b to each other. Such a hole 12 has a central axis B which is coincident with the longitudinal axis A of the coupling device 40. In this configuration, the geometry of this hole 12 and its location in the casing ring 29 are defined such that the second coupling end 33 can pass therethrough. This hole 12 comprises zones 24a, 24b for passing this second end 33 in order to operate the third and fourth functions of said watch.

With reference to FIGS. 8a to 11, this hole 12 includes first and second passage zones 24a, 24b configured for operating the third and fourth functions of the watch respectively. In other words, these two passage zones 24a, 24b make it possible to structurally configure such a through-hole 12 in order to operate the third and fourth functions of the watch. In this context, each passage zone 24a, 24b comprises a central part 26 configured for the arrangement of the main portion 23a of the insertable part 9b and thus of the second coupling end 33 in the through-hole 12, and an eccentric part 25a, 25b configured for the passage of the coupling portion 9c in this hole 12. This eccentric part 25a, 25b forms a passage allowing the coupling portion 9c to pass through the body of said casing ring 29 as far as a cooperation zone 11 defined in the inner peripheral wall 15b which will be discussed below. It is understood in this context that the two passage zones 24a, 24b share the same central part 26. In other words, the central parts 26 of these two zones 24a, 24b are coincident. In this configuration, the central part 26 extends over a distance from the outer peripheral wall 15a to the inner peripheral wall 15b of the casing ring 29, this distance being substantially shorter than the length of the main portion 23a of the insertable part 9b. A “substantially shorter” distance is understood to mean that this distance is “strictly shorter” or “appreciably shorter” than the length of the main portion 23a.

The casing ring 29 further comprises a through-opening 17 forming a recess for receiving at least one pivoting element 14 such as a lever, capable of being actuated by the ring 10 in order to interact with the mechanism of the movement implementing the third or fourth function. This casing ring 29 comprises a second resilient return element and a retaining element which are disposed in this recess and which are intended to cooperate with the pivoting element 14 in order, in particular, to place it in an initial rest position. This pivoting element 14 thus alternates between the initial position and an activation position in which part of this element 14 projects from the inner peripheral wall 15b of the casing ring 29 in order to interact with the mechanism implementing the third or fourth function to be operated. The arrangement of this pivoting element 14 in the activation position is controlled by the ring 10 and in particular by an actuating element 30 of this ring 10. It should be noted that this pivoting element 14 moves from the activation position to the initial position under the action of the second resilient return element, which causes this pivoting element 14 to move in a direction opposite to that intended to bring it to its activation position, until this element 14 comes into abutment against the retaining element.

As mentioned above, the casing ring 29 comprises a cooperation zone 11 for cooperation between the second coupling end 33 and the operating member 4. More specifically, this zone 11 is where the coupling portion 9c of this second end 32 cooperates with a coupling element 13 of the ring 10 in order to cause this ring 10 to move in the casing ring 29. Such a zone 11 is included on the inner peripheral wall 15b of the casing ring 29. In particular, this zone 11 comprises a portion of this peripheral wall 15b into which the through-hole 12 opens. In this configuration, the zone 11 includes stop elements 28 capable of cooperating with the coupling element 13 of the ring 10 so as to define the course of travel of this ring 10 which is movable in the casing ring 29.

In this device 1, the ring 10, otherwise referred to as the “movable ring”, has a shape that is configured to ensure its arrangement and movement in the support zone of the casing ring 29. In the present embodiment, this ring has a shape that is substantially circular. This ring 10 comprises upper and lower faces and inner and outer lateral faces.

As mentioned above, the ring 10 comprises said at least one actuating element 30, the coupling element 13, and at least one element for connection to the first resilient return element 18. This ring 10 includes as many actuating and connecting elements 30 as there are functions to be operated. In the present embodiment, this ring 10 comprises two actuating elements 30, a single coupling element 13 and two connecting elements capable of cooperating with two different first resilient return elements 18, as illustrated in FIGS. 1 to 3, in order to operate or control the third and fourth functions.

In this operating member 4, this actuating element 30 of the pivoting element 14 is included on the outer lateral face of the ring 10. This actuating element 30 is configured to extend towards a region 27 of the recess receiving the pivoting element 14, said region being located in the vicinity of this pivoting element 14 to be actuated. In other words, this actuating element 30 extends substantially vertically towards this region 27 and opposite the pivoting element 14. It is understood that the location of the actuating element 30 in this region 27 of the recess allows this actuating element 30 to be arranged in the immediate vicinity of the pivoting element 14. Such an arrangement allows this pivoting element 14 to be activated by this actuating element 30 so that it moves from its initial position to its activation position. This actuating element 30 projecting from the outer lateral face of the ring 10 has a shape substantially similar to that of the letter “L” by being formed of a first portion which is substantially perpendicular to this face and a second portion which is substantially parallel to this same face, said portions being substantially perpendicular to each other.

This ring 10 further comprises an element for connection to the first resilient return element 18 arranged in a recess included in the support zone of the casing ring 29. This connection element is included on the lower face of this ring 10. This element extends substantially perpendicularly from this lower face towards the bottom of the corresponding recess comprising this first resilient return element.

In other words, this connecting element is partly arranged in this recess of the support zone, between a first end of the first resilient return element 18 and a wall of this recess. This connecting element has a shape that is configured to apply or exert a stressing force on this first end with which it is in contact, the second end of this first return element 18 being able to bear against or be supported by a support wall of this recess that is arranged opposite this connecting element. It is understood that in this configuration, the connecting element being partly located in the recess is thus able to be moved within the enclosure of this recess to compress this return element 18 when the ring 10 is moving.

With reference to FIGS. 2, 9 and 10, the coupling element 13 of the ring 10 is included on the inner lateral face of this ring 10. This element 13, which is preferably made in one piece with the body of the ring 10, forms a raised portion on this face which is essentially polygonal in shape. This shape is particularly suitable for achieving optimum coupling with the coupling portion 9c of the second coupling end 33.

As mentioned above, the control device 2 further comprises the first drive element 31 which is configured to improve cooperation between the second coupling end 33, comprising the coupling portion 9c, and the coupling element 13, in order to ensure optimum displacement of the ring 10 in the support zone of the casing ring 29. More specifically, such a first drive element 31 helps to ensure that the contact established between the coupling portion 9c of the second coupling end 33 and the inner lateral face of the ring and thus the surface of the cooperation zone 11 is maintained in order to guarantee that the coupling between this coupling portion 9c and the coupling element 13 is achieved for the displacement of the ring 10 in the casing ring 29.

In this embodiment, it is understood that such a system 1 makes it possible to implement a method for operating the horological movement of the watch and in particular for operating at least one function of this watch such as the first, second, third or fourth function mentioned above.

For this purpose, this method provides for a process of activating the coupling device 40 to operate the first, second, third or fourth function of the watch. During this process, the first or second coupling end 32, 33 is mechanically connected to the functional member corresponding to the function to be operated, by manipulating the gripping element 7 in order to place it in the axial control position allowing mechanical connection with this functional member, namely:
the first axial control position for establishing a mechanical connection between the first coupling end 32 and the actuating member of the manual winding mechanism for performing the first function, in which first position the first and second drive zones 36, 37 are joined together to take part in transmitting a rotational motion from the gripping element 7 to the first drive element 31;
the second axial control position for establishing a mechanical connection between the first coupling end 33 and the hand-setting member for performing the second function, in which second position the first and second drive zones 36, 37 are joined together to take part in transmitting a rotational motion from the gripping element 7 to the first drive element 31;
the third axial control position for establishing a mechanical connection between the second coupling end 33 and the operating member 4 for performing the third or fourth function, in which third position the first and second drive zones 36, 37 are separated from each other to prevent/prohibit/deactivate the transmission of a rotational motion from the gripping element 7 to the first drive element 31.

Manipulating the gripping element 7, and thus the control device 2, makes it possible to move from one control position to another in order to select the functional member involved in performing one of the functions of the watch. It should be noted that in the present embodiment, the gripping element 7 is initially placed in the first axial control position, which corresponds to the position in which the first coupling end 32 is mechanically connected to the actuating member of the winding mechanism in order to perform the first function.

As mentioned above, when the gripping element 7 is manipulated to be arranged in the first and second control positions, the first coupling end 32 is then mechanically connected to the actuating member of the manual winding mechanism and the hand-setting member respectively.

It should be noted that when the gripping element 7 is placed in the first control position and the manual winding function carried out during a rotational motion of this gripping element 7 in this position is completed, then the method can comprise a process of deactivating the coupling device 40 during which the gripping element 7 remains placed in this first control position. When the gripping element 7 is placed in the second control position and the hand-setting function carried out during a rotational motion of this gripping element 7 in this position is completed, then the method can comprise a process of deactivating the coupling device 40. During this process, the gripping element 7 is pushed axially towards the outer surface of the middle 6, or of the movement, passing from the second position to the first control position.

Furthermore, when the gripping element 7 is manipulated to be arranged in the third control position, the second coupling end 33 is then mechanically connected to the operating member 4 by passing from the first position to the third control position which is the position where the gripping element 7 is arranged closest to the outer surface 35 of the middle 6. During this manipulation, this gripping element 7 is displaced axially from this first position towards the through-hole 12, by compressing the spring 19 arranged between the gripping element 7 and the compression piece 20 included in the control device 2. When the second coupling end 33 is located in the vicinity of or in contact with the outer peripheral wall 15a of the casing ring 29 of the operating member 4, the gripping element 7 is then rotated to insert this second coupling end 33, provided with the coupling portion 9c, into the passage zone 24a, 24b of the through-hole 12 depending on which of the third or fourth functions is to be operated. As mentioned above, in the present embodiment, the through-hole 12 can comprise two passage zones 24a, 24b, intended for operating the third and fourth functions of the watch. In this context, the gripping element 7 is thus rotated in a first direction in order to select the passage zone 24a, 24b relating to the function to be operated and to insert this second coupling end 33 therein until the shoulder 16 connecting the fastening and insertable parts 9a, 9b of the second drive element 8, comes into abutment against the outer peripheral wall 15a of the casing ring 29. Once this shoulder 16 is in abutment against the outer peripheral wall 15a, the gripping element 7 is then manipulated in a second direction opposite/contrary to the first, to be placed in the third control position in order to cooperate with the coupling element 13 of the ring 10. In this last configuration, where the gripping element 7 is in the third control position, the second coupling end 33 can then cooperate with the coupling element 13 of the ring 10 via the coupling portion 9c. It should be noted that in this third control position, the coupling portion 9c is held in abutment on the inner peripheral wall 15b of the casing ring 29 under the action of the spring 19 which exerts a resilient return force on the gripping element 7. It should be noted that the third control position is that in which the second coupling end 33 is engaged in the through-hole 12 and/or in which this second end 33 cooperates with or is coupled to the ring 10. In other words, the third control position is that in which the main portion 23a of the insertable part 9b is arranged in the through-hole 12.

Subsequently, manipulation of the gripping element 7 in the second direction of rotation generates a displacement of the ring 10 in the support zone of the casing ring 29 as a result of the cooperation between the coupling portion 9c of the second coupling end 33 and the coupling element 13 of the ring 10. This displacement continues until the coupling element 13 is in contact with the corresponding stop element 28 of the cooperation zone 11. This displacement of the ring 10 causes the first resilient return element 18, arranged in the recess defined in the support zone below this ring 10, to be stressed by means of its connection element. During this displacement, the actuating element 30 of the ring 10 actuates the corresponding pivoting element 14, causing the position of this pivoting element 14 to change and move into an activation position in which part of this element 14 projects from the inner peripheral wall 15b of the casing ring 29 in order to interact with the corresponding mechanism of the movement to implement the operated function. Subsequently, once the manipulation of the gripping element 7 has been completed, the ring 10 is automatically placed in its rest position under the action of the first resilient return element 18 which then recovers its rest shape. Placing the ring 10 in its rest position automatically places the pivoting element 14 in its initial position, as it is no longer stressed by the actuating element 30 of the ring 10.

Subsequently, the method can comprise a process of deactivating the coupling device 40 during which the gripping element 7 is manipulated, passing from the third position to the first control position. In this context, the gripping element 7 is thus rotated in the first direction until the coupling portion 9c of the second coupling end 33 is positioned facing the eccentric part 25a, 25b of the corresponding passage zone 24a, 24b of the through-hole 12 in the casing ring 29. In such a configuration, the spring 19 arranged in the first drive element 31 returns to its resting shape, causing an axial displacement of the gripping element 7 which brings about the extraction of the second coupling end 33 from this passage zone 24a, 24b and which automatically places this gripping element 7 in the first control position.

It should also be noted that in this description “substantially perpendicular” or “substantially perpendicularly” is understood to mean “strictly perpendicular” or “appreciably perpendicular”.

The invention has been described above by way of example only. It goes without saying that modifications could be made while still remaining within the scope of the claimed invention. By way of example, it is understood that the system 1 can be configured to implement more than four functions described here in this embodiment, in particular by including a casing ring 29 whose through-hole 12 comprises more than two zones for passing the second coupling end 33.

### Nomenclature

1. System for operating a horological movement of a watch
2. Control device
3. Support piece
4. Operating member
5. Watch case
6. Middle
7. Gripping element of a coupling device
8. Second drive element
9a. Fastening part
9b. Insertable part
9c. Coupling portion
10. Ring
11. Cooperation zone
12. Through-hole
13. Element for coupling a ring
14. Pivoting element of the operating member
15a. Outer peripheral wall of a casing ring
15b. Inner peripheral wall of the casing ring
16 Shoulder included on the outer surface of the second drive element
17. Through-opening
18. First resilient return element
19. Spring
20. Compression piece
21. Rod
22. Shoulder formed on the compression piece
23a. Main portion of the insertable part
23b. Terminal portion of the insertable part
24a. First passage zone
24b. Second passage zone
25a. Eccentric part of the first passage zone
25b. Eccentric part of the second passage zone
26. Central part common to the first and second passage zones
27. Region of the through-opening arranged in the vicinity of the pivoting element
28. Stop elements of the cooperation zone
29. Casing ring
30. Actuating element of the ring
31. First drive element
32. First coupling end
33. Second coupling end
34. Opening in the hollow body of the second drive element
35. Outer surface of the middle of the watch
36. First drive zone of the first drive element
37. Second drive zone of the second drive element
40. Coupling device

1. An operating system (1) for operating a horological movement of a watch, which system comprises a coupling device (40) provided with first and second coupling ends (32, 33) and first and second drive zones (36, 37), said coupling device (40) being configured to operate at least one function of this movement by comprising a control device (2) and a support piece (3) intended to be unmoving relative to the horological movement of the watch and in which piece (3) this control device (2) is movably mounted, the control device (2) comprising:
a gripping element (7) capable of being driven in a rotational motion about a longitudinal axis (A) of the coupling device (40);
a first drive element (31) including the first coupling end (32) and the first drive zone (36);
a second drive element (8) mounted such that it is rigidly connected to the gripping element (7), this second drive element (8) including the second coupling end (33) and the second drive zone (37), said second zone (37) being able to be joined to the first drive zone (36) in order to drive the first drive element (31) such that it rotates;
said elements (31, 8) being configured to transmit this rotational motion to a functional member of the movement when said gripping element (7) is arranged in an axial position for operating said function.

2. The operating system (1) according to claim 1, wherein the body of the first drive element (31) is arranged in the hollow body of the second drive element (8).

3. The operating system (1) according to claim 1, wherein a part of the body of the first drive element (31) provided with the first coupling end (32) projects from an opening (34) formed in the second coupling end (33) of the hollow body of the second drive element (8).

4. The operating system (1) according to claim 1, wherein the first and second drive elements (31, 33) are coaxial.

5. The operating system (1) according to claim 1, wherein the first coupling end (32) of the first drive element (31) is configured to be arranged in the movement of the watch when the gripping element (7) is in any of its axial positions.

6. The operating system (1) according to claim 1, wherein the second coupling end (33) of the second drive element (8) is configured to be arranged outside the movement of the watch when the gripping element (7) is in any of its axial positions.

7. The operating system (1) according to claim 1, wherein the first coupling end (32) is configured to transmit said rotational motion to:
an actuating member of a manual winding mechanism of said system (1), which mechanism is capable of storing mechanical energy when said gripping element (7) is arranged in a first axial position for operating a first function of the watch, and in which first position the first and second drive zones (36, 37) are joined together;
a hand-setting member of said system (1) when said gripping element (7) is arranged in a second axial position for operating a second function of the watch, and in which second position the first and second drive zones (36, 37) are joined together.

8. The operating system (1) according to claim 1, wherein the second coupling end (33) is configured to transmit said rotational motion to an operating member (4) of said system when said gripping element (7) is arranged in a third axial position for operating third and fourth functions of the watch, in which third position the first and second drive zones (36, 37) are separated from each other.

9. The operating system (1) according to claim 1, wherein the first drive element (31) can translate axially and can rotate about the longitudinal axis (A) relative to the second drive element (8).

10. The operating system (1) according to claim 1, wherein the first drive zone (36) is formed on an outer surface of the first drive element (31) and the second drive zone (37) is formed on an inner surface of the second drive element (8).

11. The operating system (1) according to claim 1, wherein the first and second drive zones (36, 37) are arranged opposite each other in the coupling device (40).

12. The operating system (1) according to claim 1, wherein the first and second drive zones (36, 37) are configured to cooperate with each other in frictional contact so as to transmit the rotational motion of the gripping element (7) to the first drive element (31) via the second drive element (8).

13. A watch comprising the operating system (1) according to claim 1.
